(19) United States
(12) Patent Application Publication
(10) Pub. No.: US 2024/0390219 A1
(43) Pub. Date: Nov. 28, 2024

(54) SYSTEM AND METHOD FOR CONTROLLING A DEVICE BASED ON MOTION

(71) Applicant: HYTTO PTE. LTD, Singapore (SG)

(72) Inventors: Dan LIU, Guangzhou (CN); Jilin QIU, Guangzhou (CN)

(73) Assignee: HYTTO PTE. LTD, Singapore (SG)

(21) Appl. No.: 18/795,267

(22) Filed: Aug. 6, 2024

Related U.S. Application Data
(63) Continuation-in-part of application No. 17/520,889, filed on Nov. 8, 2021.

(51) Int. Cl. A61H 19/00; A61H 9/00; A61H 23/02; G05B 19/042; H04L 67/125

(52) U.S. Cl. CPC A61H 19/44; A61H 9/0057; A61H 23/0254; G05B 19/042; H04L 67/125; A61H 2201/0207; A61H 2201/0228; A61H 2201/1669; A61H 2201/1671; A61H 2201/1676; A61H 2201/5005; A61H 2201/5046; A61H 2201/5064; A61H 2201/5079; A61H 2201/5084; A61H 2201/5097; G05B 2219/23067

(57) ABSTRACT

A system includes a memory with executable instructions and a processor coupled with it. The processor is set to execute the instructions, causing the system, via a control application on the user device, to provide real-time or near real-time communication between the user device (with at least one sensor) and the sexual entertainment accessory (with at least one sexual entertainment action actuator). It obtains user input for accessory control, senses the user device's motion when the input meets the motion sensing activation condition, acquires motion data (like acceleration, velocity, and position data), gets corresponding action indicator data based on the motion data within predetermined ranges, and controls the actuator to perform the corresponding sexual entertainment action in real-time or near real-time following the device's motion and at a level or intensity indicated by the action indicator data, enabling the accessory to synchronously achieve the related action.

### CROSS REFERENCE TO RELATED APPLICATIONS

This application is a continuation-in-part of U.S. application Ser. No. 17/520,889, filed on Nov. 8, 2021. The above application is hereby incorporated by reference in its entirety.

### FIELD OF THE INVENTION

The present disclosure generally relates to a system and method for controlling a device, and more particularly to a system and method for controlling a device based on motion.

### BACKGROUND OF THE INVENTION

In the field of sexual entertainment products, Prior art has typically involved manual control interfaces for sexual entertainment accessory, lacking dynamic interactivity that mirrors user movements or gestures in real time. Existing systems may use static settings or pre-programmed sequences that do not adapt to the user's actions during usage. In recent years, advancements in sensor technology and wireless communication have enabled more sophisticated interactions between electronic devices. Motion sensors have become ubiquitous in smartphones and wearable devices, allowing for the detection of various types of movement. However, these capabilities have not been fully exploited in the context of sexual entertainment accessory, where a high degree of personalization and interactive feedback could significantly enhance user experience. Moreover, there is a growing demand for personalized and responsive entertainment solutions that can adapt to individual preferences and behaviors. Traditional sexual entertainment accessory often fail to provide this level of customization and interactivity, leading to a less engaging and less satisfying user experience.

Therefore, there exists a need for an improved system that provides a more intuitive and immersive experience.

The exemplary disclosed system and method are directed to overcoming one or more of the shortcomings set forth above and/or other deficiencies in existing technology.

### SUMMARY OF THE INVENTION

Various embodiments of the present disclosure disclose systems and methods for integrating motion sensing capabilities with sexual entertainment accessory, facilitating a new level of interactivity and personalization in adult entertainment products and enhancing the user experience.

In one exemplary aspect, the present disclosure is directed to a system. The system includes: a memory storing executable instructions; and a processor operatively coupled with the memory, the processor is configured to execute the executable instructions to cause the system to at least: provide real-time or near real-time communication between a user device including at least one sensor and a sexual entertainment accessory including at least one sexual entertainment action actuator through a control application installed on the user device; obtain input related to control of the sexual entertainment accessory and provided by a user via the user device through the control application; sense, in response to the input satisfying an activation condition for motion sensing, motion of the user device via the at least one sensor, obtain at least one motion data corresponding to the at least one sensor through the control application; wherein, the at least one of motion data comprising at least one of acceleration, velocity, and position data; obtain, based on the at least one of motion data that falls within at least one range of a plurality of predetermined ranges through the control application, at least one of action indicator data corresponding to the at least one sexual entertainment action actuator; a value of the action indicator data at least indicating a level or intensity of the at least one sexual entertainment action actuator of the sexual entertainment accessory to achieve at least one sexual entertainment action indicator, wherein, the value of the action indicator data is proportional or inversely proportional to a value of the motion data; control, based on the at least one action indicator data, the at least one sexual entertainment action actuator through the control application to perform a predetermined sexual entertainment action corresponding to the motion in real time or near real time following the motion of the user device, and at a level or intensity corresponding to the at least one action indicator data, so that the sexual entertainment accessory is capable of following the motion of the user device to synchronously achieve the at least one sexual entertainment action indicator corresponding to the at least one of action indicator data.

In another aspect, the present disclosure is directed to a method. The method comprises: providing real-time or near real-time communication between a user device including at least one sensor and a sexual entertainment accessory including at least one sexual entertainment action actuator through a control application installed on the user device; obtaining input related to control of the sexual entertainment accessory and provided by a user via the user device through the control application; sensing, in response to the input satisfying an activation condition for motion sensing, motion of the user device via the at least one sensor, obtain at least one motion data corresponding to the at least one sensor through the control application; wherein, the at least one of motion data comprising at least one of acceleration, velocity, and position data; obtaining, based on the at least one of motion data through the control application, at least one of action indicator data corresponding to the at least one sexual entertainment action actuator; a value of the action indicator data at least indicating a level or intensity of the at least one sexual entertainment action actuator of the sexual entertainment accessory to achieve at least one sexual entertainment action indicator, wherein, the value of the action indicator data is proportional or inversely proportional to a value of the motion data; controlling, based on the at least one action indicator data, the at least one sexual entertainment action actuator through the control application to perform a predetermined sexual entertainment action corresponding to the motion in real time or near real time following the motion of the user device, and at a level or intensity corresponding to the at least one action indicator data, so that the sexual entertainment accessory is capable of following the motion of the user device to synchronously achieve the at least one sexual entertainment action indicator corresponding to the at least one of action indicator data.

In another aspect, the present disclosure is directed to a non-transitory computer-readable storage medium. The non-transitory computer-readable storage medium comprises: machine-readable instructions, the machine-readable instructions when executed by a processor of a controller, enable the controller to: provide real-time or near real-time communication between a user device including at least one sensor and a sexual entertainment accessory including at least one sexual entertainment action actuator through a control application installed on the user device; obtain input related to control of the sexual entertainment accessory and provided by a user via the user device through the control application; sense, in response to the input satisfying an activation condition for motion sensing, motion of the user device via the at least one sensor, obtain at least one motion data corresponding to the at least one sensor through the control application; wherein, the at least one of motion data comprising at least one of acceleration, velocity, and position data; obtain, based on the at least one of motion data through the control application, at least one of action indicator data corresponding to the at least one sexual entertainment action actuator; a value of the action indicator data at least indicating a level or intensity of the at least one sexual entertainment action actuator of the sexual entertainment accessory to achieve at least one sexual entertainment action indicator, wherein, the value of the action indicator data is proportional or inversely proportional to a value of the motion data; control, based on the at least one action indicator data, the at least one sexual entertainment action actuator through the control application to perform a predetermined sexual entertainment action corresponding to the motion in real time or near real time following the motion of the user device, and at a level or intensity corresponding to the at least one action indicator data, so that the sexual entertainment accessory is capable of following the motion of the user device to synchronously achieve the at least one sexual entertainment action indicator corresponding to the at least one of action indicator data.

### BRIEF DESCRIPTION OF THE DRAWINGS

FIG. 1 is a schematic illustration of an exemplary system of the present invention;

FIG. 2 is a schematic illustration of an exemplary system of the present invention;

FIG. 3 is a flowchart showing an exemplary process of the present invention;

FIG. 4 is a flowchart detail showing an exemplary process of the present invention;

FIG. 5 is a flowchart detail showing an exemplary process of the present invention;

FIG. 6 is a flowchart detail showing an exemplary process of the present invention;

FIG. 7 is a flowchart detail showing an exemplary process of the present invention;

FIG. 8 is a flowchart showing an exemplary process of the present invention;

FIG. 9 is a schematic illustration of an exemplary computing device, in accordance with at least some exemplary embodiments of the present disclosure; and

FIG. 10 is a schematic illustration of an exemplary network, in accordance with at least some exemplary embodiments of the present disclosure.

### DETAILED DESCRIPTION AND INDUSTRIAL APPLICABILITY

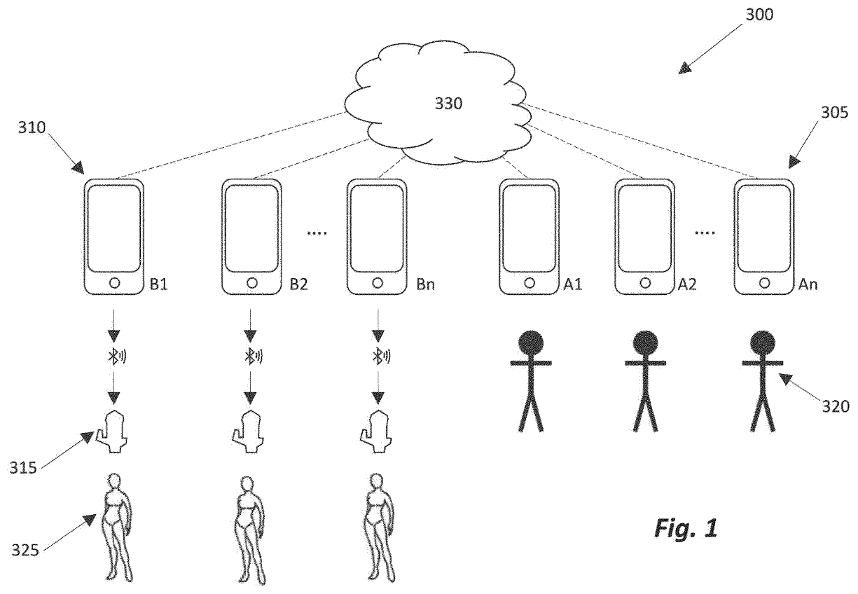

FIG. 1 illustrates an exemplary system 300 for controlling a device based on motion. In at least some exemplary embodiments, system 300 may be a system for controlling a device based on motion in real-time (e.g., in real-time or in near real-time) for an adult entertainment application.

As illustrated in FIG. 1, system 300 may include one or more user devices 305, one or more model devices 310, and one or more accessories 315. For example, system 300 may include a plurality of user devices 305, a plurality of model devices 310, and a plurality of accessories 315. Data such as image data, audio data, and/or control data may be transferred between user devices 305, model devices 310, and accessories 315.

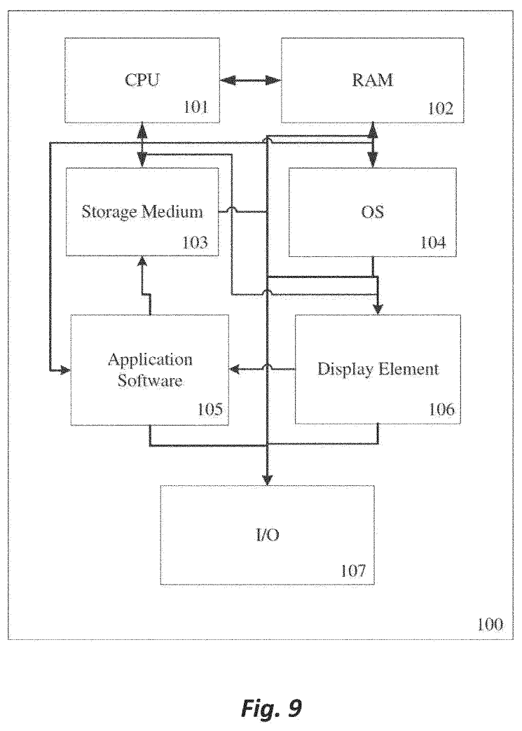

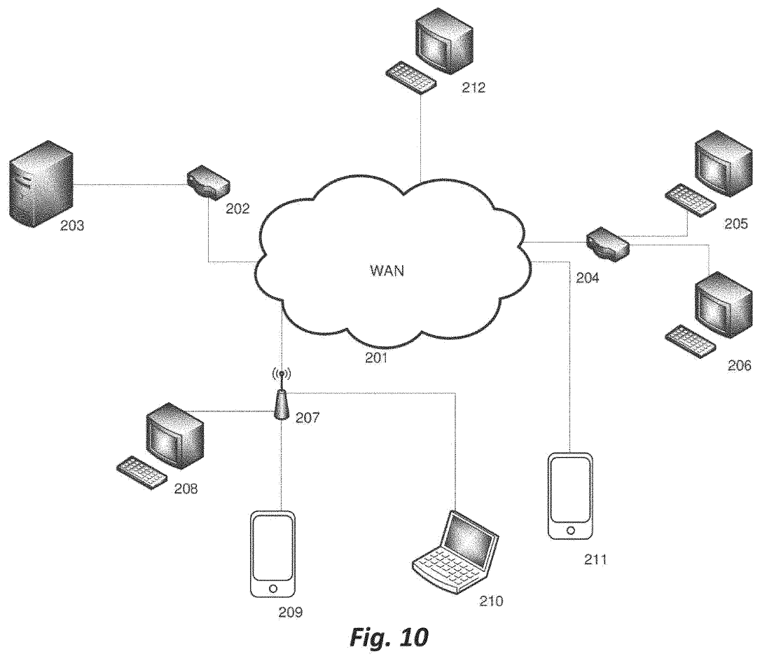

As illustrated in FIG. 1, system 300 may include any desired number of user devices 305 (e.g., A1, A2, . . . . An). User device 305 may be any suitable device for interfacing with other components of system 300 such as a computing device (e.g., user interface). For example, user device 305 may be any suitable user interface for receiving input and/or providing output (e.g., image data) to a user 320. User device 305 may include a camera and a microphone. User device 305 may be, for example, a touchscreen device (e.g., of a smartphone, a tablet, a smartboard, and/or any suitable computer device), a wearable device, a computer keyboard and monitor (e.g., desktop or laptop), an audio-based device for entering input and/or receiving output via sound, a tactile-based device for entering input and receiving output based on touch or feel, a dedicated user interface designed to work specifically with other components of system 300, and/or any other suitable user interface (e.g., including components and/or configured to work with components described below regarding FIGS. 9 and 10). For example, user device 305 may include a touchscreen device of a smartphone or handheld tablet. For example, user device 305 may include a display (e.g., a computing device display, a touchscreen display, and/or any other suitable type of display) that may provide output, image data, and/or any other desired output or input prompt to a user. For example, the exemplary display may include a graphical user interface to facilitate entry of input by a user and/or receiving output such as image data. An application for example as described herein and/or a web browser may be installed on user device 305 and utilized by user 320.

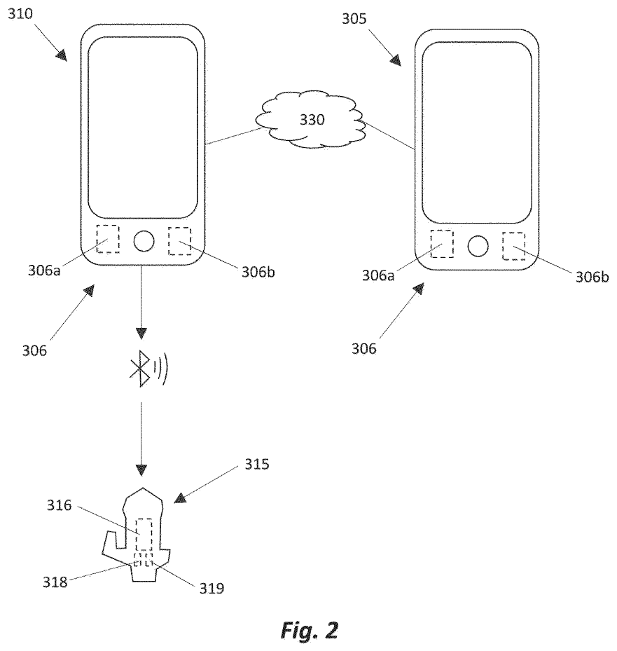

As illustrated in FIG. 2, user device 305 may include a sensor array 306. In at least some exemplary embodiments, sensor array 306 may include one or more sensors integrated or built into the exemplary disclosed user device (e.g., user device 305) such as, for example, a mobile phone, a pad, or a wearable device. Sensor array 306 may include any suitable sensors for use with system 300 such as, for example, a location sensor 306a and a movement sensor 306b. Location sensor 306a may include a GPS device, a Galileo device, a GLONASS device, an IRNSS device, a BeiDou device, and/or any other suitable device that may operate with a global navigation system.

Movement sensor 306b may be include any suitable components for sensing motion (e.g., motion amplitude), velocity, and/or acceleration. Movement sensor 306b may include an acceleration sensor. Movement sensor 306b may include a gyroscope. For example, movement sensor 306b may include a displacement sensor, a velocity sensor, and/or an accelerometer. For example, movement sensor 306b may include components such as a servo accelerometer, a piezoelectric accelerometer, a potentiometric accelerometer, and/or a strain gauge accelerometer. Movement sensor 306b may include a piezoelectric velocity sensor or any other suitable type of velocity or acceleration sensor.

System 300 may include any desired number of model devices 310 (e.g., B1, B2, . . . . Bn). Model device 310 may be similar to user device 305. For example, model device 310 may be any suitable user interface for receiving input and/or providing output (e.g., image data) to a model 325. Model 325 may operate model device 310 to record and transfer image (e.g., video) and audio data to one or more users 320 via a network 330.

Accessory 315 may be any suitable accessory for use by model 325 (e.g., when model 325 is imaged by model device 310). Accessory 315 can also be any suitable accessory for other users (e.g., the user of the user device). For example, accessory 315 may be a prop that is used by model 325 while model 325 is being imaged (e.g., a video or pictures of model 325 are being recorded and/or transmitted in real-time to be viewed by user 320). For example, accessory 315 may be a device used for erotic stimulation (e.g., a sex aid or a “sex toy”). In at least some exemplary embodiments, accessory 315 may be a massaging apparatus for human genitalia (e.g., a vibrator). For example, accessory 315 may be any suitable device for use in a video or pictures recorded by model device 310, which may be an erotic video or erotic pictures). In at least some exemplary embodiments, accessory 315 may be a tool or other indicator that may be used in video or pictures recorded by model device 310 such as surveying equipment, a sign providing information such as location or time information, a surveillance tool used by model 325, and/or any other suitable tool or accessory that may be used while model device 310 is recording a video or pictures of model 325. For example, model 325 may be an erotic model using accessory 315 that may be an erotic device, a technician or laborer using accessory 315 that may be a tool or work device specific to a desired application, an operative using accessory 315 that may be a surveillance tool or a part of a weapon system being recorded by model device 310, and/or any other desired role using any suitable accessory 315. For example, accessory 315 is a sexual entertainment accessory (e.g., accessory 315 is a sexual entertainment accessory of the user).

Accessory 315 may include at least one sexual entertainment action actuator. The sexual entertainment action actuator could be a motor 316, a heater or other action actuators. Motor 316 may include an electric motor. Motor 316 may include a server motor, a stepper motor, a brushless motor, or any other suitable type of motor. Motor 316 may include any suitable vibration motor or haptic motor such as, for example, a mini vibrator motor. Motor 316 may include a low voltage motor. Motor 316 may include a pager motor or a coin vibration motor. Motor 316 may include a linear resonant actuator or an eccentric rotating mass vibration motor. Motor 316 may be powered by any suitable power source, such as a battery (e.g., a nickel-metal hydride battery, a lithium-ion battery, an ultracapacitor battery, a lead-acid battery, and/or a nickel cadmium battery), an electric power source (e.g., a transformer connected to a plug that may plug into an outlet), and/or any other suitable energy source. Accessory 315 may include a controller 319 that may be any suitable computing device for controlling an operation of motor 316 and a communication device 318. Controller 319 may, for example, include components similar to the components described below regarding FIG. 9. Controller 319 may include for example a processor (e.g., micro-processing logic control device) or board components. Controller 319 may control motor 316 based on input data and/or commands received from user device 305 and/or model device 310 via network 330 and/or communication device 318 (e.g., transferred directly to communication device 318 by any suitable component of system 300). Motor 316 may be controlled by controller 319 to vibrate accessory 315 at a desired level or strength, perform a suction operation at a desired level or strength using accessory 315 (e.g., using accessory 315 as a suction device), rotate or swing accessory 315 at a desired speed or amount, contract or expand accessory 315 by a desired amount, and/or cause accessory 315 to perform any other suitable action or function.

In at least some exemplary embodiments, motor 316 may be or may include a thermal device such as a heater. In at least some exemplary embodiments, motor 316 may include an electric heating device such as an electric resistance heating device. Motor 316 may include a polyimide heater, a silicone rubber heater, and/or a resistive wire heater. Motor 316 may be controlled by controller 319 to heat or emit heat or warmth from accessory 315.

Network 330 may be any suitable communication network over which data may be transferred between user devices 305, model devices 310, and/or accessories 315. Network 330 may be the internet, a LAN (e.g., via Ethernet LAN), a WAN, a WiFi network, or any other suitable network. Network 330 may be similar to WAN 201 described below. The components of system 300 may also be directly connected (e.g., by wire, cable, USB connection, and/or any other suitable electro-mechanical connection) to each other and/or connected via network 330. For example, components of system 300 may wirelessly transmit data by any suitable technique such as, e.g., wirelessly transmitting data via 4G LTE networks (e.g., or 5G networks) or any other suitable data transmission technique for example via network communication. Components of system 300 may transfer data via the exemplary techniques described below regarding FIG. 10. User devices 305, model devices 310, and/or accessories 315 may include any suitable communication components for communicating with other components of system 300 using for example the communication techniques described above. For example, user devices 305 and model devices 310 may include integrally formed communication devices (e.g., smartphone components), and accessory 315 may include communication device 318 that may communicate using any of the exemplary disclosed communication techniques.

In at least some exemplary embodiments, a given accessory 315 may communicate with a given model device 310 (e.g., a paired model device 310) via any suitable short distance communication technique. For example, accessories 315 (e.g., via communication device 318) and model devices 310 may communicate via Wifi, Bluetooth, ZigBee, NFC, IrDA, and/or any other suitable short distance technique. Accessory 315 may be an adult toy that may be connected with model device 310 through short distance wireless communication. An application (e.g., operating using the exemplary disclosed modules) may be installed on model device 310, the application and model device 310 being configured to send commands to accessory 315 to actuate accessory 315. As an example, the application may be a control application installed on the user device for controlling the sexual entertainment accessory, and the user may open the control application on the user device and establish a real-time or near real-time communication connection between the user device and the sexual entertainment accessory by means of a communication connection operation (e.g., the user clicks a Bluetooth start button, a Bluetooth connection button, a WiFi start button, or a WiFi connection button, etc., on the operation interface of the control application). After establishing the communication connection between the user device and the sexual entertainment accessory, the user may control the sexual entertainment accessory by operating the control application, which may process relevant data or signal generated by the user device during the process of controlling the sexual entertainment accessory (e.g., obtaining inputs from the user or motion data sensed by the user device, converting motion data sensed by the user device, etc.), and may process relevant data or signal feedback from the sexual entertainment accessory.

System 300 may include one or modules for performing the exemplary disclosed operations. The one or more modules may include an accessory control module for controlling accessory 315. The one or more modules may be stored and operated by any suitable components of system 300 (e.g., including processor components) such as, for example, network 330, user device 305, model device 310, accessory 315, and/or any other suitable component of system 300. For example, system 300 may include one or more modules having computer-executable code stored in non-volatile memory. System 300 may also include one or more storages (e.g., buffer storages) that may include components similar to the exemplary disclosed computing device and network components described below regarding FIGS. 9 and 10. For example, the exemplary disclosed buffer storage may include components similar to the exemplary storage medium and RAM described below regarding FIG. 9. The exemplary disclosed buffer storage may be implemented in software and/or a fixed memory location in hardware of system 300. The exemplary disclosed buffer storage (e.g., a data buffer) may store data temporarily during an operation of system 300.

The exemplary disclosed system, apparatus, and method may be used in any suitable application telecommunications application. The exemplary disclosed system, apparatus, and method may be used in any suitable application for providing images of a model such as a human model to a user such as a remotely-located user. The exemplary disclosed system, apparatus, and method may be used in any suitable application for providing entertainment based on viewing images or videos. For example, the exemplary disclosed system, apparatus, and method may be used in any suitable application for controlling an imaging device such as a user device and a device operated by a human model being imaged by the imaging device. The exemplary disclosed system, apparatus, and method may be used in any suitable telecommunication application for adult entertainment.

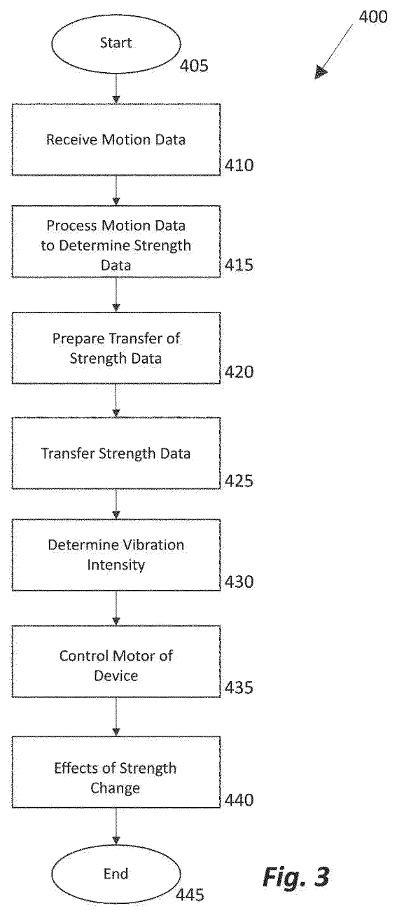

An exemplary operation of the exemplary disclosed system, apparatus, and method will now be described. For example, FIG. 3 illustrates an exemplary process 400 of system 300. Process 400 begins at step 405.

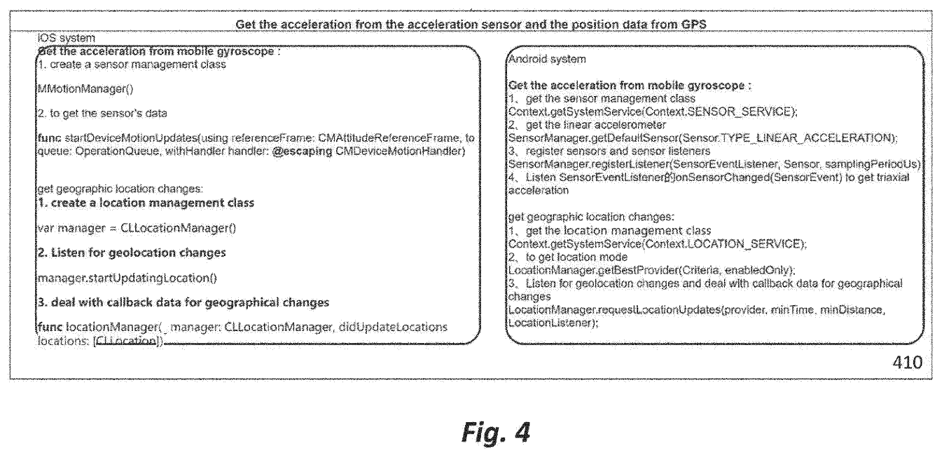

At steps 405 and 410 of FIG. 3 and as illustrated in more detail in FIG. 4, system 300 may run an application (e.g., an app using an application program interface based on an operation of user device 305, model device 310, and/or any other suitable component of system 300). As illustrated in the exemplary embodiment of FIG. 4, system 300 may obtain motion data including acceleration, velocity, and position data from location sensor 306a and movement sensor 306b.

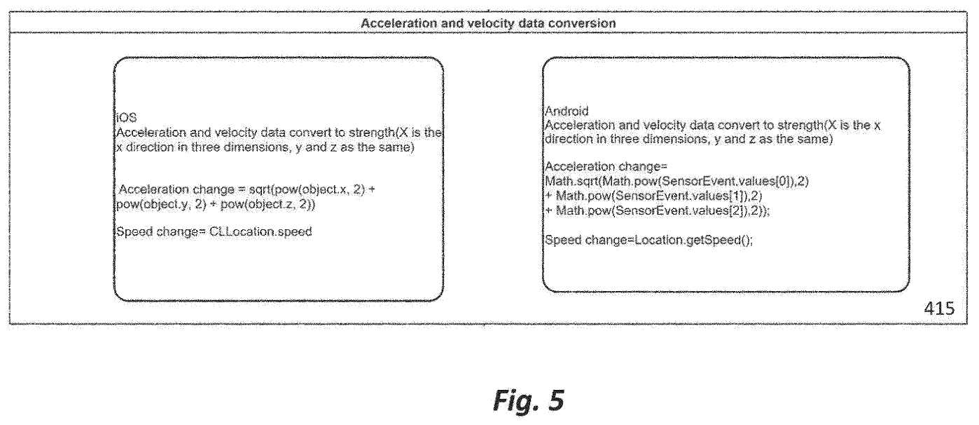

At step 415 of FIG. 3 and as illustrated in more detail in FIG. 5, system 300 may process the exemplary disclosed motion data to determine strength data for example as described herein. For example, system 300 may convert acceleration data and/or velocity data to strength data. For example, the action indicator data includes at least one of strength data, vibration frequency data, linear motion speed data, linear motion distance data, rotational speed data, rotational angle data, swing frequency data, swing speed data, suction frequency data, heating temperature data, heating power data, or other relevant data of various sexual entertainment action indicators that can be performed by the sexual entertainment accessory. As an illustration, the sexual entertainment action indicator can be understood as an indicator representing the performance, level, or effect of the sexual entertainment action realized by the sexual entertainment action actuator of the sexual entertainment accessory. This indicator can be the intensity, frequency, speed, level, mode, or other physical action performance, level, or effect of various sexual entertainment actions of the sexual entertainment accessory. Among them, the sexual entertainment action actuator includes at least one motor or at least one heater. For instance, the user device is a smartphone equipped with an accelerometer and a gyroscope, and the sexual entertainment accessory is an adult toy capable of producing vibrations. When the user shakes the smartphone, the motion sensors in the smartphone capture the acceleration data. If this acceleration data falls within a preset range, the control application installed on the smartphone converts the acceleration data into vibration intensity data for the vibrating motor of the sexual entertainment accessory, and uses this vibration intensity data to control the vibrating motor of the sexual entertainment accessory to vibrate at the corresponding vibration intensity via the control application, thereby allowing the sexual entertainment accessory to synchronize its vibrations with the motion of the smartphone at the corresponding vibration intensity. Another example is that the user device is a smartphone equipped with sensors such as an accelerometer and a gyroscope, and the sexual entertainment accessory is an adult toy capable of producing rotational motion. When the user rotates the smartphone, the gyroscope and other sensors in the smartphone capture the direction change data. If this direction data falls within a preset range, the control application installed on the smartphone converts the direction change data into rotational angle data for the rotating motor of the sexual entertainment accessory, and uses this rotational angle data to control the rotating motor of the sexual entertainment accessory to rotate at the corresponding rotational angle via the control application, thereby allowing the sexual entertainment accessory to synchronize its rotation with the rotation speed of the smartphone at the corresponding rotational speed.

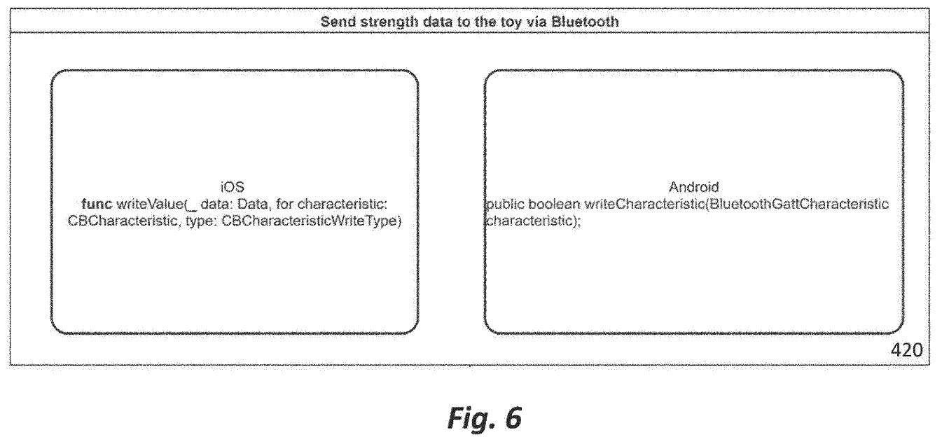

At step 420 of FIG. 3 and as illustrated in more detail in FIG. 6, system 300 may prepare a transfer of strength data. For example, system 300 may transfer strength data between one or more user devices 305, model devices 310, and/or network 330. At step 425, system 300 may transfer strength data to one or more accessories 315 (e.g., via Bluetooth from one or more model devices 310 to one or more accessories 315).

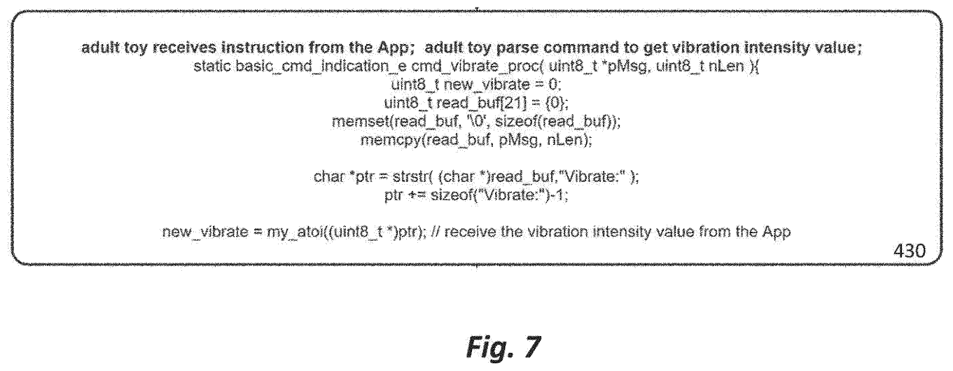

At step 430 of FIG. 3 and as illustrated in more detail in FIG. 7, system 300 may determine a vibration intensity (e.g., a vibration intensity value). For example, communication device 318 of accessory 315 may receive data and instructions from system 300 based on steps 415 through 425, and controller 319 (e.g., and/or any other suitable components of system 300) may determine a vibration intensity value.

Returning to FIG. 3 at step 435, system 300 may control (e.g., via controller 319 and/or directly via model device 310) motor 316. For example, controller 319 may control an operation of motor 316 (e.g., to vibrate relatively stronger or weaker) based on the exemplary disclosed vibration intensity value. At step 440, an effect of the strength change (e.g., vibration strength change) may be felt. For example, model 325 may feel the strength change produced by accessory 315 (e.g., based on tactile touch or feeling of accessory 315 on a body portion of model 325). Process 400 ends at step 445.

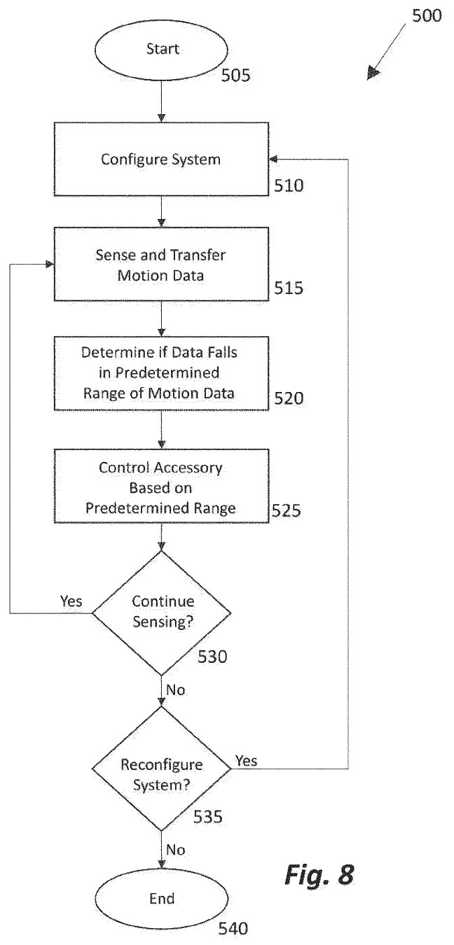

Another exemplary operation of the exemplary disclosed system, apparatus, and method will now be described. For example, FIG. 8 illustrates an exemplary process 500. Process 500 begins at step 505.

At step 510, system 300 may be configured. For example, system 300 may be configured as illustrated in FIG. 1 or with any other suitable configuration. Any desired number and arrangement of user devices 305, model devices 310, and accessories 315 may be provided in system 300. In at least some exemplary embodiments, system 300 may be a system that operates based on real-time motion of a user device (e.g., user device 305) for use in adult entertainment. For example, system 300 may sense and transfer data, process data, and control accessory 315 in real-time or in near real-time based on real-time (e.g., or near real-time) motion of user device 305 (e.g., and/or based on motion of model device 310 in at least some exemplary embodiments). Accessory 315 (e.g., an operable adult toy) may be configured to receive data and signals from other components of system 300 for example as described herein. The exemplary disclosed module, storage (e.g., storage buffer), and hardware may include a memory having stored thereon instructions, a processor configured to execute the instructions resulting in a software application, and a software application configured to perform process 500.

In at least some exemplary embodiments at step 510, user 320 may install an application of system 300 on user device 305 (e.g., and/or model 325 may install the application on model device 310). User 320 (e.g., and/or model 325) may authorize the application to access the data of sensor array 306 (e.g., an acceleration sensor and a GPS) of user device 305 (e.g., and/or model device 310). User 320 (e.g., and/or model 325) may also authorize the application to access the data of Bluetooth or any other suitable communication components of user device 305 (e.g., and/or model device 310). Model 325 (e.g., and/or user 320) may also connect accessory 315 to model device 310 (e.g., and/or user device 305) via Bluetooth or any other suitable communication technique. As an example, the user's authorization of the application can serve as an input related to controlling the sexual entertainment accessory. When the control application determines that this input satisfies the predefined activation condition (for instance, when the user authorizes the application to access the data of the sensor array 306), the control application can control the sensors of the user device to detect the motion of the user device. Additionally, this application can function as a control application for controlling the sexual entertainment accessory. One scenario for this input is the user opening the control application installed on the user device. Upon opening the control application and entering its predetermined operating interface (which is used to trigger the sexual entertainment accessory to synchronize its actions with the motion of the user device), the control application will control the sensors of the user device to detect its motion. In this case, the activation condition refers to the user operating the control application to enter the predetermined operating interface. As another scenario, the user opening the control application installed on the user device can also serve as an input. When the user opens the control application and enters its predetermined operating interface, a control button is displayed on the interface (this control button is used to trigger the sexual entertainment accessory to synchronize its actions with the motion of the user device). When the user operates this control button, the control application will control the sensors of the user device to detect its motion. In this case, the activation condition refers to the user operating the control button.

At step 515, system 300 may operate to sense and transfer motion data. One or more models 325 may initiate communication (e.g., start a chat session) using model devices 310 with one or more users 320 using user devices 305 (e.g., or one or more users 320 may initiate communication with one or more models 325). For example, users 320 and models 325 may chat using the exemplary disclosed modules (e.g., applications) described herein. Model 325 utilizing model device 310 may receive and approve a request (e.g., a toy control request) sent by user 320 utilizing user device 305, the request if approved allowing user 320 to control accessory 315 operated by model 325 for example as described herein. System 300 may detect motion data (e.g., a real-time motion amplitude) of the exemplary disclosed device (e.g., user device 305), the motion amplitude including movement speed and movement acceleration of the device. Location sensor 306a may sense position data of user device 305 (e.g., and/or model device 310). Movement sensor 306b may sense acceleration and/or velocity data of user device 305 (e.g., and/or model device 310). User device 305 (e.g., and/or model device 310) may transfer the sensed motion data of location sensor 306a and movement sensor 306b to any desired component of system 300 (e.g., to network 330 or any other components of system 300 including the exemplary disclosed modules, storage, and/or processors). In at least some exemplary embodiments, position data can include at least one of coordinate data (which can be sensed by GPS modules), altitude data (which can be sensed by GPS modules), tilt angle data (which can be sensed by gyroscope or calculated by fusing data from accelerometer and magnetometer to determine the tilt angle of the user device), direction data (which can be sensed by magnetometer, electronic compasses, or by fusing data from accelerometer and magnetometer), displacement data (which can be calculated by comprehensively analyzing data sensed by accelerometer and gyroscope to determine the displacement of the user device in space), and proximity distance data (such as the distance of the target approaching the screen, which can be sensed by proximity sensors). Position data can be detected by a single sensor or detected and fused by multiple sensors. For example, the user device is the user's smartphone, and when the user shakes the smartphone, the smartphone's built-in position sensors such as accelerometer and gyroscope respond immediately to capture the dynamic changes of the smartphone. The accelerometer measures the change in acceleration of the smartphone in three-dimensional space, while the gyroscope tracks the angle of rotation of the phone around each axis, which together builds up information about the displacement distance and direction of the smartphone. These data are analyzed and converted in real-time, and used to control sexual entertainment accessory after conversion. For example, if the user quickly shakes the smartphone to the right, the accelerometer detects a significant positive acceleration on the X-axis, and the gyroscope records the angle of rotation around the Y-axis, confirming that the smartphone is moving right. The control application receives these positional datas and translates it into control commands for the sexual entertainment accessory, prompting the sexual entertainment accessory to perform sexual actions in the same or corresponding direction (e.g., to the right or in the opposite direction) and with a corresponding amount of displacement (which can be calculated based on the displacement distance of the mobile phone's shaking). This immediate feedback mechanism ensures that the sexual entertainment actions of the sexual entertainment accessory are closely synchronised with the user's movement of the user device, creating a smooth, natural and highly interactive experience.

In at least some exemplary embodiments and at step 515, system 300 may be configured (e.g., the exemplary disclosed one or more modules may be configured) to define (e.g., set up or to have) one or more ranges of rewards. Rewards may be a tip or virtual currency that may be purchased or credited to a user (e.g., user 320) using any suitable payment technique. Rewards may be awarded from user 320 to model 325 based on a performance of model 325 viewed by user 320 (e.g., adult entertainment). An application of system 300 operating based on the exemplary disclosed modules may be configured to receive reward messages or data from external devices (e.g., user device 305 and/or any other suitable external device). The reward messages or data may include a reward amount. System 300 may determine whether the reward (e.g., reward data) falls into one or more predetermined reward ranges (e.g., reward amount ranges). The one or more predetermined reward amount ranges may correspond to the exemplary disclosed predetermined ranges described at step 520. If a reward (e.g., a tip) falls within one or more predetermined reward amount ranges, accessory 315 may be controlled for example as described at step 525. As an example, the reward can serve as an input related to controlling the sexual entertainment accessory. When the control application determines that this input satisfies the predefined activation condition (for instance, when the reward falls into one or more predetermined reward ranges), the control application can control the sensors of the user device to detect its motion.

At step 520, system 300 may operate to determine whether the magnitude of the motion data (e.g., motion amplitude) is within a predetermined range or one or more of a plurality of predetermined ranges (e.g., falls within one or more preset motion amplitude parameters). For example, the motion amplitude parameters may include one or more ranges of motion amplitude and/or actions (e.g., as described herein) corresponding or correlating to each of the one or more ranges. The exemplary disclosed modules, storage, and/or processors that may be integrated with user device 305, network 330, and/or any other suitable component of system 300 may determine whether the sensed motion data falls within one or more of the exemplary disclosed plurality of ranges. A predefined action or function of accessory 315 (e.g., for example as described at step 525) may be associated with each of the plurality of predetermined ranges. In at least some exemplary embodiments, the exemplary disclosed predetermined ranges may correspond to the exemplary disclosed rewards described above.

In at least some exemplary embodiments, the plurality of predetermined ranges may be a plurality of speed mode parameters of one or more ranges. The speed mode parameters may correspond to a plurality of transportation modes (e.g., traffic patterns) having one or more general speeds or speed ranges corresponding to each of the transportation modes. The transportation modes (e.g., traffic patterns) may include a walking mode having a speed range of between about 1 km/hour (kilometer per hour) and about 5 km/hour (e.g., a general speed of 2 km/hour), a bicycle mode having a speed range of between about 5 km/hour and about 29 km/hour (e.g., a general speed of 6 km/hour), a car mode having a speed range of between about 50 km/hour and about 90 km/hour (e.g., a general speed of 60 km/hour), a ship mode having a speed range of between about 25 km/hour and about 50 km/hour (e.g., a general speed of 30 km/hour), a high-speed train mode having a speed range of between about 180 km/hour and about 350 km/hour (e.g., a general speed of 200 km/hour), an airplane mode having a speed range of between about 350 km/hour and about 950 km/hour (e.g., a general speed of 400 km/hour), and/or any other desired transportation mode.

At step 525, system 300 may operate to control accessory 315 based on the predetermined range or ranges into which the motion data may fall (e.g., determined at step 520). For example, if the sensed motion data may be within (e.g., the motion amplitude falls within) a given predetermined range of the plurality of predetermined ranges, system 300 may control accessory 315 (e.g., an adult toy) to perform a predetermined action or function (e.g., predefined act) depending on a level or an amount of the motion data. Controller 319 may control motor 316 to actuate and/or cause accessory 315 to perform the predetermined action or function at a desired level or intensity. The predetermined action or function may include accessory 315 operating to sexually stimulate model 325 (e.g., an operator of accessory 315 that may be an adult toy). The predetermined action or function corresponding to the predetermined range may include accessory 315 vibrating at a desired level or strength, accessory 315 performing a suction operation at a desired level or strength, accessory 315 rotating or swinging at a desired speed or amount, accessory 315 emitting heat at a desired level or strength, accessory 315 contracting or expanding by a desired amount, and/or any other suitable action or function. User 320 may view the operation of accessory 315 operated by model 325 via an operation of user device 305, model device 310, network 330, and/or any other suitable components of system 300. In at least some exemplary embodiments, when the motion data detected by the sensor of the user device falls within any of the predetermined ranges, the system 300 considers this to constitute a valid input signal on which it can respond. For example, the system 300 generates action indicator data based on the motion data, which in turn controls the response of the sexual entertainment accessory.

At step 525 and in at least some exemplary embodiments, controller 319 may control motor 316 to actuate or cause accessory 315 to increase or decrease a level or intensity of the predetermined action or function based on the predetermined range identified at step 520. For example as a value (e.g., a speed) of the predetermined range increases (e.g., increasing from a car mode to an airplane mode), controller 319 may cause motor 316 to actuate or cause accessory 315 to increase a level or intensity of the predetermined action or function. As a value of the predetermined range decreases, controller 319 may cause motor 316 to actuate or cause accessory 315 to decrease a level or intensity of the predetermined action or function. For example, motor 316 may be controlled by controller 319 to vibrate accessory 315 at an increased or a decreased level or strength (e.g., intensity), perform a suction operation at an increased or a decreased level or strength (e.g., intensity), rotate or swing accessory 315 at an increased or a decreased level or strength (e.g., intensity), contract or expand accessory 315 by an increased or a decreased amount, increase or decrease a temperature or an amount of heat emitted from accessory 315, and/or cause accessory 315 to perform any other suitable action or function at an increased or a decreased level or strength (e.g., intensity). Motor 316 may also be controlled directly by any other suitable component of system 300 (e.g., user device 305, network 330, or model device 310) for example via communication device 318.

In at least some exemplary embodiments, as motion data sensed and transferred at step 515 increases (e.g., a velocity and/or acceleration of user device 305 increases), controller 319 may cause motor 316 to actuate or cause accessory 315 to increase a level or intensity of the predetermined action or function at step 525 based on the determination at step 520. As motion data sensed and transferred at step 515 decreases (e.g., a velocity and/or acceleration of user device 305 decreases), controller 319 may cause motor 316 to actuate or cause accessory 315 to decrease a level or intensity of the predetermined action or function at step 525 based on the determination at step 520.

In at least some exemplary embodiments, each type of action indicator data corresponds to one type of sexual entertainment action actuator of the sexual entertainment accessory, and each type of sexual entertainment action actuator is configured to perform a corresponding type of sexual entertainment action. For example, the user device includes an accelerometer for detecting changes in the motion speed of the user device, and the sexual entertainment accessory has the sexual stimulation function of vibrating to stimulate human sexual organs. The sexual entertainment accessory includes a vibration motor for controlling the sexual entertainment accessory to achieve vibration. The control application converts the acceleration change data detected by the accelerometer into action indicator data, with the value of this action indicator data at least indicating a level or intensity of the vibration motor of the sexual entertainment accessory to achieve vibration indicator (such as vibration intensity or frequency). For instance, when the user picks up a smartphone with the control application installed and starts shaking it with varying force, the acceleration changes detected by the built-in accelerometer of the smartphone are transmitted to the control application. The application interprets these data, mapping the magnitude of acceleration to the vibration intensity of the vibration motor. Thus, if the user shakes the smartphone gently, the vibration motor in the sexual entertainment accessory will vibrate at a lower intensity; whereas, when the user shakes the phone with more force, the vibration intensity of the vibration motor will correspondingly increase, enabling dynamic adjustment of the vibration intensity. Furthermore, the user device includes at least two motion sensors, and the motion data corresponds to at least two types. Each type of action indicator data at least corresponds to a type of at least one sexual entertainment action actuator in the sexual entertainment accessory, and each type of at least one sexual entertainment action actuator is configured to perform a particular type of sexual entertainment action. For instance, the user device includes an accelerometer for detecting changes in the motion speed of the user device and a gyroscope for detecting changes in the rotation angle of the user device. The sexual entertainment accessory has two sexual stimulation functions: rotating to stimulate human sexual organs and linearly reciprocating to stimulate human sexual organs. The sexual entertainment accessory includes a first motor for controlling the sexual entertainment accessory to achieve rotational motion and a second motor for controlling the sexual entertainment accessory to achieve linear reciprocating motion. The control application converts the acceleration change data detected by the accelerometer into the first type of action indicator data, with the value of this data at least indicating a level or intensity of the first motor of the sexual entertainment accessory to achieve rotation indicator (such as rotation speed or angle). The control application also converts the rotation angle change data detected by the gyroscope into the second type of action indicator data, with the value of this data at least indicating a level or intensity of the second motor of the sexual entertainment accessory to achieve linear reciprocating motion indicator (such as linear movement distance or speed). As another example, the user device such as a smartphone, includes both a gyroscope and an accelerometer. When the user tilts the phone, the gyroscope detects the tilt angle and direction, while the accelerometer records the linear acceleration of the phone. These data are transmitted to the control application, which analyzes them to determine the intensity and pattern of vibration in the sexual entertainment accessory. For instance, the greater the tilt angle of the phone, the higher the vibration intensity of the sexual entertainment accessory; the faster the rotation speed of the phone, the faster the vibration frequency. In this scenario, the tilt angle corresponds to the vibration intensity, while the rotation speed corresponds to the vibration frequency, with both monitored by the gyroscope and accelerometer, respectively, and converted into different actions of the accessory.

In at least some exemplary embodiments, if a reward (e.g., a tip) falls within one or more predetermined ranges of rewards, controller 319 may cause motor 316 to actuate or cause accessory 315 to operate at a level or intensity of the predetermined action or function corresponding to the predetermined range of rewards. For example, controller 319 may cause motor 316 to actuate accessory 315 (e.g., an adult toy) to perform the predetermined action or function based on an amount of said reward (e.g., at a predetermined intensity corresponding to the reward) to sexually stimulate model 325 operating accessory 315.

In at least some exemplary embodiments, accessory 315 may be connected by the exemplary disclosed short range communication techniques to user device 305 and operated by user 320. Model 325 may control an operation of accessory 315 via model device 310, network 330, and user device 305 similarly to as described above.

At step 530, system 300 may determine whether or not motion data sensing is to continue based on, for example, input provided by user 320, a predetermined operation or algorithm of the exemplary disclosed module, and/or any other suitable criteria. If motion data sensing is to continue, system 300 may return to step 515. System 300 may repeat steps 515 through 530 for any desired number of iterations. If motion data sensing is not to continue, system 300 may proceed to step 535.

At step 535, system 300 may determine whether or not system 300 is to be reconfigured based on, for example, input provided by user 320, a predetermined operation or algorithm of the exemplary disclosed module, and/or any other suitable criteria. If system 300 is to be reconfigured, system 300 may return to step 510. System 300 may repeat steps 510 through 535 for any desired number of iterations. If system 300 is not to be reconfigured, system 300 may proceed to step 540, at which process 500 ends.

In at least some exemplary embodiments, system 300 may provide an interactive interface related to the control of the sexual entertainment accessory on a display with which the user device is configured through the control application. And system 300 may dynamically display an indicator graphic through the control application on the interactive interface in real time or near real time following the motion of the user device; the indicator graphic comprising at least one indicator element, display parameter of the at least one indicator element corresponding to data parameter of the at least one motion data or data parameter of the at least one action indicator data. This enables the user to visualise the state of motion of the user device or the response of the sexual entertainment accessory, thus facilitating the user's personalised control of the sexual entertainment accessory. The system 300 provides an interface with a user device (e.g. a smartphone), the system 300 provides a control application connected to the user device (e.g., a smartphone) that has a graphical user interface (GUI) that allows the user to control the sexual entertainment accessory through touch, movement, or other forms of interaction. In the interface of the control application, the system displays an indicator graphic, which may include any visual aspect of the indicator element, and the indicator element in the indicator graphic reflects the motion or operation of the user device in real time. The motion data (e.g., acceleration, angular velocity, etc.) of the user device is captured and converted into a set of data parameters, based on which the control application can change the display parameters of the indicator graphic. Wherein the display parameter comprises at least one of colour, direction, length, height, width, magnitude, numerical value, shape, quantity, coordinate parameter, size, and kinetic style. The display parameter of the indicator element is updated in real time based on changes in the above data parameters, thereby providing intuitive feedback to the user.

For example, the indicator element is visual component on the user interface that reflects the motion or operation status of the user device. The indicator element can take various forms, such as dynamic icons: icons can change their color, shape, size, or animation effects based on the movement of the user device. For instance, a heart-shaped icon might rotate as the phone tilts or grow larger and glow brighter as the acceleration increases. Indicator element can be progress bars, which display a continuous range, such as from 0% to 100%, to indicate the intensity of device motion or the level of a certain parameter. Users can change the position of the progress bar through mobile device movements, such as filling the progress bar faster as the acceleration increases. Indicator element can be dashboards or gauges, displaying a pointer or filled area to indicate the current status or level, for example, changing the direction of the dashboard's pointer based on the orientation detected by the gyroscope. Indicator element can be signal waveforms that vary over time, visualizations of the device's vibration frequency or intensity (e.g., as the user shakes the device faster, the vibration frequency of the signal waveform also increases. Similarly, as the user shakes the device faster, the vibration intensity of the signal waveform also intensifies), or recordings of the user's movement trajectories. Indicator element can be animated characters or avatars, using cartoon images or 3D models, whose movements and expressions correspond to the inputs of the user device, providing more vivid feedback. Of course, multiple elements can be combined, such as icons and digital readings, or animations and background music, to offer a richer user experience.

The exemplary disclosed system may operate for example as described herein based on motion data provided by sensor array 306 of user device 305. The exemplary disclosed system may also operate for example similarly to as described herein based on motion data provided by sensor array 306 of model device 310.

In at least some exemplary embodiments, the exemplary disclosed system, apparatus, and method may include using sensor array 306 of user device 305 (e.g., and/or model device 310) to obtain motion data (e.g., a mobile phone's own acceleration sensor and GPS to obtain a moving speed or acceleration), and transferring and using the moving speed or acceleration to determine a certain value (e.g., a strength data) by the exemplary disclosed algorithms. The strength value may be transmitted to accessory 315 (e.g., a toy) via Bluetooth or any other suitable technique, which may be analyzed by the toy (e.g., controller 319 and/or any other suitable component of system 300 using the exemplary disclosed module) and converted into a vibration intensity of motor 316 (e.g., the toy motor), so as to product (e.g., realize) the toy vibration based on the user device movement synchronization.

In at least some exemplary embodiments, system 300 may define a plurality of preset sensitivity ranges. Each of the exemplary disclosed predetermined ranges may include or correspond to a predetermined or preset sensitivity. The preset sensitivity may vary between any desired values. For example, the preset sensitivity may vary from a level 0 to a level 3 (e.g., 0, 1, 2, and 3). Each of the levels may include an adjustable scale (e.g., a 100 adjustable scale that may vary from 0 to 100 for each level).

In at least some exemplary embodiments, system 300 may define a plurality of preset basic motion amplitude ranges. Each of the exemplary disclosed predetermined ranges may include or correspond to a predetermined or preset basic motion amplitude. The preset basic motion amplitudes may vary between any desired values. For example, the preset basic motion amplitudes may correspond to the exemplary disclosed general speeds of the plurality of transportation modes (e.g., traffic patterns) described above.

In at least some exemplary embodiments, system 300 may determine (e.g., calculate) a new motion amplitude based on the exemplary disclosed preset basic motion amplitude and preset sensitivity described above, and actuate accessory 315 based on the new motion amplitude (e.g., to sexually stimulate model 325 who may be an operator of accessory 315 that may be an adult toy). For example when the motion data includes the real-time acceleration of the exemplary device (e.g., user device 305), the new motion amplitude may be calculated as: new motion amplitude=the preset basic motion amplitude+ (real-time acceleration*preset sensitivity). For example, the preset sensitivity may correspond to a range into which the sensed real-time acceleration falls (e.g., determined according to step 520).

In at least some exemplary embodiments, system 300 may determine (e.g., calculate) a new motion amplitude based on the real-time velocity and the exemplary disclosed general speed when the motion data includes the real-time velocity of the exemplary device (e.g., real-time speed of user device 305), and actuate accessory 315 based on the new motion amplitude (e.g., to sexually stimulate model 325 who may be an operator of accessory 315 that may be an adult toy). For example, a value for velocity per unit strength=(the exemplary disclosed general speed)/(a preset adult level value). The preset adult level value may be 20 or any other suitable value. The new motion amplitude may be calculated as: new motion amplitude=(real-time speed)/(velocity per unit strength). The exemplary disclosed general speed may be changed based on sensed data of user device 305 (e.g., based on a sensed velocity or acceleration of user device changing for example as described at step 515).

In at least some exemplary embodiments, system 300 may determine the new motion amplitude based on the real-time speed, the preset sensitivity, and the general speed. The exemplary disclosed adjustable scale of the preset sensitivity level may be adjusted according to the exemplary disclosed traffic patterns. The new motion amplitude may be calculated as: new motion amplitude=(real-time speed/velocity per unit strength)*sensitivity.

In at least some exemplary embodiments, the exemplary disclosed system may include an accessory control module, comprising computer-executable code stored in non-volatile memory, a processor, a user device (e.g., user device 305 or model device 310) including at least one sensor, and an accessory for a human model, the accessory including a motor or a heater. The accessory control module, the processor, the user device, and the accessory may be configured to sense a velocity or an acceleration of the user device using the at least one sensor, determine if the sensed velocity or the sensed acceleration falls within at least one range of a plurality of predetermined ranges, and control the motor or the heater to drive a predetermined action of the accessory based on the at least one range. The accessory may be an adult toy and the predetermined action may be at least one selected from the group of performing a suction operation, vibrating the accessory, rotating the accessory, swinging the accessory, emitting heat from the accessory, contracting the accessory, expanding the accessory, and combinations thereof. The accessory control module, the processor, the user device, and the accessory may be further configured to intensify a level of operation of the motor or the heater as the sensed velocity or the sensed acceleration increases, and decrease a level of operation of the motor or the heater as the sensed velocity or the sensed acceleration decreases. The at least one sensor may be built into the user device. The user device may be at least one selected from the group of a mobile phone, a mobile pad, a wearable device, and combinations thereof. The exemplary disclosed system may also include a model device of the human model. The model device may be connected to the accessory via short distance wireless communication. An application of the accessory control module may be installed on the model device, the application configured to transfer commands from the model device to the accessory for controlling the motor or heater. The short distance wireless communication may be at least one selected from the group of WiFi, Bluetooth, ZigBee, NFC, IrDA, and combinations thereof. The accessory control module, the processor, the user device, and the accessory may be further configured to define one or more ranges of rewards including a tip or virtual currency, receive a reward data from the user device or an external device, the reward data including a reward amount, determine whether the reward data falls into one or more predetermined reward amount ranges, and control the motor or the heater to drive the predetermined action of the accessory based on the one or more predetermined reward amount ranges. The predetermined action of the accessory may include sexually stimulating the human model. The accessory control module, the processor, the user device, and the accessory may be further configured to define a plurality of preset sensitivity ranges, determine a new velocity or a new acceleration based on the plurality of preset sensitivity ranges and the sensed velocity or the sensed acceleration, and control the motor or the heater to drive the predetermined action of the accessory based on the new velocity or the new acceleration. The predetermined action of the accessory may include sexually stimulating the human model. The accessory control module, the processor, the user device, and the accessory may be further configured to define a plurality of preset basic motion amplitude ranges, and determine a new motion amplitude, wherein the new motion amplitude is equal to a value of one of the plurality of preset basic motion amplitude ranges plus the product of the new acceleration multiplied by a value of one of the plurality of preset sensitivity ranges. The accessory control module, the processor, the user device, and the accessory may be further configured to define a speed mode parameter for at least one of the plurality of predetermined ranges. The speed mode parameter may include a predetermined transportation mode and one or more general speeds corresponding to the predetermined transportation mode. The predetermined transportation mode may be at least one selected from the group of a walking mode, a bicycle mode, a car mode, a ship mode, a high speed train mode, an airplane mode, and combinations thereof. The accessory control module, the processor, the user device, and the accessory may be further configured to determine a new motion amplitude based on the velocity and at least one of the one or more general speeds, and control the motor or the heater to drive the predetermined action of the accessory based on the new motion amplitude. The predetermined action of the accessory may include sexually stimulating the human model.

In at least some exemplary embodiments, the exemplary disclosed system may include an accessory control module, comprising computer-executable code stored in non-volatile memory, a processor, a user device operated by a user, a model device operated by a human model, at least one sensor of the user device or the model device, and an accessory for the human model disposed remotely from the user, the accessory including a motor or a heater. The accessory control module, the processor, the user device, the model device, and the accessory may be configured to provide real-time communication between the user device and the model device, sense a velocity or an acceleration of the user device or the model device using the at least one sensor, determine if the sensed velocity or the sensed acceleration falls within at least one range of a plurality of predetermined ranges, and control the motor or the heater to drive a predetermined action of the accessory based on the at least one range. The accessory may be an adult toy and the predetermined action may be at least one selected from the group of performing a suction operation, vibrating the accessory, rotating the accessory, swinging the accessory, emitting heat from the accessory, contracting the accessory, expanding the accessory, and combinations thereof. The accessory control module, the processor, the user device, the model device, and the accessory may be further configured to intensify a level of operation of the motor or the heater as the sensed velocity or the sensed acceleration increases, and decrease a level of operation of the motor or the heater as the sensed velocity or the sensed acceleration decreases. The at least one sensor may be built into the user device or the model device. The user device or the model device may be at least one selected from the group of a mobile phone, a mobile pad, a wearable device, and combinations thereof. The model device may be connected to the accessory via short distance wireless communication, and an application of the accessory control module may be installed on the model device, the application configured to transfer commands from the model device to the accessory for controlling the motor or heater. The short distance wireless communication may be at least one selected from the group of WiFi, Bluetooth, ZigBee, NFC, IrDA, and combinations thereof. The accessory control module, the processor, the user device, the model device, and the accessory may be further configured to define one or more ranges of rewards including a tip or virtual currency, receive a reward data from the user device or an external device, the reward data including a reward amount, determine whether the reward data falls into one or more predetermined reward amount ranges, and control the motor or the heater to drive the predetermined action of the accessory based on the one or more predetermined reward amount ranges. The predetermined action of the accessory may include sexually stimulating the human model. The accessory control module, the processor, the user device, the model device, and the accessory may be further configured to define a plurality of preset sensitivity ranges, determine a new velocity or a new acceleration based on the plurality of preset sensitivity ranges and the sensed velocity or the sensed acceleration, and control the motor or the heater to drive the predetermined action of the accessory based on the new velocity or the new acceleration. The predetermined action of the accessory may include sexually stimulating the human model. The accessory control module, the processor, the user device, the model device, and the accessory may be further configured to define a plurality of preset basic motion amplitude ranges, and determine a new motion amplitude, wherein the new motion amplitude may be equal to a value of one of the plurality of preset basic motion amplitude ranges plus the product of the new acceleration multiplied by a value of one of the plurality of preset sensitivity ranges. The accessory control module, the processor, the user device, the model device, and the accessory may be further configured to define a speed mode parameter for at least one of the plurality of predetermined ranges. The speed mode parameter may include a predetermined transportation mode and one or more general speeds corresponding to the predetermined transportation mode. The predetermined transportation mode may be at least one selected from the group of a walking mode, a bicycle mode, a car mode, a ship mode, a high-speed train mode, an airplane mode, and combinations thereof. The accessory control module, the processor, the user device, the model device, and the accessory may be further configured to determine a new motion amplitude based on the velocity and at least one of the one or more general speeds, and control the motor or the heater to drive the predetermined action of the accessory based on the new motion amplitude. The predetermined action of the accessory may include sexually stimulating the human model.

In at least some exemplary embodiments, the exemplary disclosed method may include providing a user device operated by a user, providing a model device operated by a human model, providing an accessory including a motor or a heater for the human model, providing real-time communication between the user device and the model device, sensing a velocity or an acceleration of the user device using at least one sensor, determining if the sensed velocity or the sensed acceleration falls within at least one range of a plurality of predetermined ranges, and controlling the motor or the heater to drive a predetermined action of the accessory based on the at least one range. The accessory may be an adult toy and the predetermined action may be at least one selected from the group of performing a suction operation, vibrating the accessory, rotating the accessory, swinging the accessory, emitting heat from the accessory, contracting the accessory, expanding the accessory, and combinations thereof. The exemplary disclosed method may also include intensifying a level of operation of the motor or the heater as the sensed velocity or the sensed acceleration increases, and decreasing a level of operation of the motor or the heater as the sensed velocity or the sensed acceleration decreases. The at least one sensor may be built into the user device, and the user device may be at least one selected from the group of a mobile phone, a mobile pad, a wearable device, and combinations thereof. The model device may be connected to the accessory via short distance wireless communication. An application of the accessory control module may be installed on the model device, the application configured to transfer commands from the model device to the accessory for controlling the motor or heater. The short distance wireless communication may be at least one selected from the group of WiFi, Bluetooth, ZigBec, NFC, IrDA, and combinations thereof. The exemplary disclosed method may further include defining one or more ranges of rewards including a tip or virtual currency, receiving a reward data from the user device or an external device, the reward data including a reward amount, determining whether the reward data falls into one or more predetermined reward amount ranges, and controlling the motor or the heater to drive the predetermined action of the accessory based on the one or more predetermined reward amount ranges. The predetermined action of the accessory may include sexually stimulating the human model. The exemplary disclosed method may further include defining a plurality of preset sensitivity ranges, determining a new velocity or a new acceleration based on the plurality of preset sensitivity ranges and the sensed velocity or the sensed acceleration, and controlling the motor or the heater to drive the predetermined action of the accessory based on the new velocity or the new acceleration. The predetermined action of the accessory may include sexually stimulating the human model. The exemplary disclosed method may further include defining a plurality of preset basic motion amplitude ranges, and determining a new motion amplitude, wherein the new motion amplitude may be equal to a value of one of the plurality of preset basic motion amplitude ranges plus the product of the new acceleration multiplied by a value of one of the plurality of preset sensitivity ranges. The exemplary disclosed method may further include defining a speed mode parameter for at least one of the plurality of predetermined ranges. The speed mode parameter may include a predetermined transportation mode and one or more general speeds corresponding to the predetermined transportation mode. The predetermined transportation mode may be at least one selected from the group of a walking mode, a bicycle mode, a car mode, a ship mode, a high-speed train mode, an airplane mode, and combinations thereof. The exemplary disclosed method may further include determining a new motion amplitude based on the velocity and at least one of the one or more general speeds, and controlling the motor or the heater to drive the predetermined action of the accessory based on the new motion amplitude. The predetermined action of the accessory may include sexually stimulating the human model.

The exemplary disclosed system, apparatus, and method may provide an efficient and effective technique for controlling imaging devices such as user devices that provide images of a human model such as a human model and devices operated by the human model based on conditions associated with a user viewing the model. For example, the exemplary disclosed system, apparatus, and method may control devices operated by the human model based on conditions associated with a user viewing the model such as, for example, a speed and acceleration of the user device, which may enhance a viewing experience of the user.

In at least some exemplary embodiments, the exemplary disclosed system, apparatus, and method may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

An illustrative representation of a computing device appropriate for use with embodiments of the system of the present disclosure is shown in FIG. 9. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 10, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 10, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 10, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on-any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A system, comprising:
a memory storing executable instructions; and
a processor operatively coupled with the memory, the processor is configured to execute the executable instructions to cause the system to at least:
provide real-time or near real-time communication between a user device including at least one sensor and a sexual entertainment accessory including at least one sexual entertainment action actuator through a control application installed on the user device;
obtain input related to control of the sexual entertainment accessory and provided by a user via the user device through the control application;
sense, in response to the input satisfying an activation condition for motion sensing, motion of the user device via the at least one sensor, obtain at least one motion data corresponding to the at least one sensor through the control application; wherein, the at least one of motion data comprising at least one of acceleration, velocity, and position data;
obtain, based on the at least one of motion data that falls within at least one range of a plurality of predetermined ranges through the control application, at least one of action indicator data corresponding to the at least one sexual entertainment action actuator; a value of the action indicator data at least indicating a level or intensity of the at least one sexual entertainment action actuator of the sexual entertainment accessory to achieve at least one sexual entertainment action indicator, wherein, the value of the action indicator data is proportional or inversely proportional to a value of the motion data;
control, based on the at least one action indicator data, the at least one sexual entertainment action actuator through the control application to perform a predetermined sexual entertainment action corresponding to the motion in real time or near real time following the motion of the user device, and at a level or intensity corresponding to the at least one action indicator data, so that the sexual entertainment accessory is capable of following the motion of the user device to synchronously achieve the at least one sexual entertainment action indicator corresponding to the at least one of action indicator data.

2. The system of claim 1, wherein:
each type of action indicator data corresponds to one type of sexual entertainment action actuator of the sexual entertainment accessory, and each type of sexual entertainment action actuator is configured to perform a corresponding type of sexual entertainment action.

3. The system of claim 1, wherein:
the motion of the user device results from a movement operation of the user device by the user holding the user device.

4. The system of claim 3, wherein the processor is further configured to execute the executable instructions to cause the system to at least:
provide, through the control application, an interactive interface related to the control of the sexual entertainment accessory on a display with which the user device is configured;
dynamically display an indicator graphic through the control application on the interactive interface in real time or near real time following the motion of the user device; the indicator graphic comprising at least one indicator element, display parameter of the at least one indicator element corresponding to data parameter of the at least one motion data or data parameter of the at least one action indicator data.

5. The system of claim 1, wherein:
the user device is connected to the sexual entertainment accessory via short distance wireless communication.

6. The system of claim 1, wherein:
the at least one sexual entertainment action actuator includes at least one motor or at least one heater.

7. The system of claim 1, wherein:
the sexual entertainment accessory is an adult toy and the predetermined sexual entertainment action is at least one selected from the group of performing a suction operation, vibrating the sexual entertainment accessory, rotating the sexual entertainment accessory, swinging the sexual entertainment accessory, emitting heat from the sexual entertainment accessory, contracting the sexual entertainment accessory, expanding the sexual entertainment accessory, and combinations thereof.

8. The system of claim 1, wherein the processor is further configured to:
intensify a level of operation of the at least one sexual entertainment action actuator as the sensed velocity or the sensed acceleration increases; and
decrease a level of operation of the at least one sexual entertainment action actuator as the sensed velocity or the sensed acceleration decreases.

9. The system of claim 1, wherein:
the at least one sensor is built into the user device; and
the user device is at least one selected from the group of a mobile phone, a mobile pad, a wearable device, and combinations thereof.

10. The system of claim 1, wherein the processor is further configured to:
define a plurality of preset sensitivity ranges;
determine a new velocity or a new acceleration based on the plurality of preset sensitivity ranges and the sensed velocity or the sensed acceleration; and
control the at least one sexual entertainment action actuator to drive the predetermined sexual entertainment action of the sexual entertainment accessory based on the new velocity or the new acceleration;
wherein the predetermined sexual entertainment action of the sexual entertainment accessory includes sexually stimulating the user.

11. The system of claim 10, wherein
the processor is further configured to:
define a plurality of preset basic motion amplitude ranges; and
determine a new motion amplitude, wherein the new motion amplitude is equal to a value of one of the plurality of preset basic motion amplitude ranges plus the product of the new acceleration multiplied by a value of one of the plurality of preset sensitivity ranges.

12. The system of claim 1, wherein the processor is further configured to:
define a speed mode parameter for at least one of the plurality of predetermined ranges;
wherein the speed mode parameter includes a predetermined transportation mode and one or more general speeds corresponding to the predetermined transportation mode; and
wherein the predetermined transportation mode is at least one selected from the group of a walking mode, a bicycle mode, a car mode, a ship mode, a high-speed train mode, an airplane mode, and combinations thereof.

13. The system of claim 12, wherein the processor is further configured to:
determine a new motion amplitude based on the velocity and at least one of the one or more general speeds; and
control the at least one sexual entertainment action actuator to drive the predetermined sexual entertainment action of the sexual entertainment accessory based on the new motion amplitude;
wherein the predetermined sexual entertainment action of the sexual entertainment accessory includes sexually stimulating the human model.

14. A method, comprising:
providing real-time or near real-time communication between a user device including at least one sensor and a sexual entertainment accessory including at least one sexual entertainment action actuator through a control application installed on the user device;
obtaining input related to control of the sexual entertainment accessory and provided by a user via the user device through the control application;
sensing, in response to the input satisfying an activation condition for motion sensing, motion of the user device via the at least one sensor, obtain at least one motion data corresponding to the at least one sensor through the control application; wherein, the at least one of motion data comprising at least one of acceleration, velocity, and position data;
obtaining, based on the at least one of motion data through the control application, at least one of action indicator data corresponding to the at least one sexual entertainment action actuator;
a value of the action indicator data at least indicating a level or intensity of the at least one sexual entertainment action actuator of the sexual entertainment accessory to achieve at least one sexual entertainment action indicator, wherein, the value of the action indicator data is proportional or inversely proportional to a value of the motion data;
controlling, based on the at least one action indicator data, the at least one sexual entertainment action actuator through the control application to perform a predetermined sexual entertainment action corresponding to the motion in real time or near real time following the motion of the user device, and at a level or intensity corresponding to the at least one action indicator data, so that the sexual entertainment accessory is capable of following the motion of the user device to synchronously achieve the at least one sexual entertainment action indicator corresponding to the at least one of action indicator data.

15. The method of claim 14, wherein:
each type of action indicator data corresponds to one type of sexual entertainment action actuator of the sexual entertainment accessory, and each type of sexual entertainment action actuator is configured to perform a corresponding type of sexual entertainment action.

16. The method of claim 14, wherein:
the motion of the user device results from a movement operation of the user device by the user holding the user device.

17. The method of claim 16, wherein the processor is further configured to execute the executable instructions to cause the method to at least:
provide, through the control application, an interactive interface related to the control of the sexual entertainment accessory on a display with which the user device is configured;
dynamically display an indicator graphic through the control application on the interactive interface in real time or near real time following the motion of the user device; the indicator graphic comprising at least one indicator element, display parameter of the at least one indicator element corresponding to data parameter of the at least one motion data or data parameter of the at least one action indicator data.

18. The method of claim 14, wherein:
the user device is connected to the sexual entertainment accessory via short distance wireless communication.

19. The method of claim 14, wherein:
the at least one sexual entertainment action actuator includes at least one motor or at least one heater.

20. A non-transitory computer-readable storage medium, comprising:
machine-readable instructions,
the machine-readable instructions when executed by a processor of a controller, enable the controller to:
provide real-time or near real-time communication between a user device including at least one sensor and a sexual entertainment accessory including at least one sexual entertainment action actuator through a control application installed on the user device;
obtain input related to control of the sexual entertainment accessory and provided by a user via the user device through the control application;
sense, in response to the input satisfying an activation condition for motion sensing, motion of the user device via the at least one sensor, obtain at least one motion data corresponding to the at least one sensor through the control application; wherein, the at least one of motion data comprising at least one of acceleration, velocity, and position data;
obtain, based on the at least one of motion data through the control application, at least one of action indicator data corresponding to the at least one sexual entertainment action actuator; a value of the action indicator data at least indicating a level or intensity of the at least one sexual entertainment action actuator of the sexual entertainment accessory to achieve at least one sexual entertainment action indicator, wherein, the value of the action indicator data is proportional or inversely proportional to a value of the motion data;
control, based on the at least one action indicator data, the at least one sexual entertainment action actuator through the control application to perform a predetermined sexual entertainment action corresponding to the motion in real time or near real time following the motion of the user device, and at a level or intensity corresponding to the at least one action indicator data, so that the sexual entertainment accessory is capable of following the motion of the user device to synchronously achieve the at least one sexual entertainment action indicator corresponding to the at least one of action indicator data.
